(19) United States
(12) Patent Application Publication
(10) Pub. No.: US 2017/0010773 A1
(43) Pub. Date: Jan. 12, 2017

(54) A COLLABORATIVE SYSTEM AND METHOD FOR PUBLISHING MULTI-MEDIA INTERACTIVE CONTENT

(71) Applicant: Felice Curcelli, Saratoga, CA (US)

(72) Inventor: Felice Curcelli, Saratoga, CA (US)

(21) Appl. No.: 15/112,483

(22) PCT Filed: Dec. 19, 2012
(86) PCT No.: PCT/US2012/070487

§ 371 Date: Jul. 19, 2016

Related U.S. Application Data
(60) Provisional application No. 61/741,755, filed on Jul. 27, 2012.

(51) Int. Cl. G06F 3/0483; G06F 3/0482; G06F 3/0484; G06F 17/24

(52) U.S. Cl. CPC G06F 3/0483; G06F 17/248; G06F 3/0482; G06F 3/04847; G06Q 20/102

(57) ABSTRACT

The present invention generally relates to the automation of generating online books, as collection of documents, and specifically eBooks. Specifically, this invention relates to a system and method for allowing multiple users, without any particular knowledge of publishing or computer systems, to collaborate over one or more networks and generate multimedia interactive documents and ebooks.

### CROSS REFERENCE TO RELATED APPLICATIONS

This application is a continuation in part of U.S. Provisional Patent Application No. 61/741,755 filed Jul. 27, 2012, the entire disclosure of which is incorporated herein by reference.

### FIELD OF THE INVENTION

The present invention generally relates to the automation of generating online books, as collection of documents, and specifically eBooks. Specifically, this invention relates to a system and method for allowing multiple users, without any particular knowledge of publishing or computer systems, to collaborate over one or more networks and generate multimedia interactive documents and ebooks.

### BACKGROUND OF THE INVENTION

Currently, online and electronic publishing programs are limited in a number of respects. First, many available methods require a user have a level of technical sophistication in addition to investing a substantial amount of time in learning to use the program. Additionally, current publishing methods fail to provide a means that allow multiple users to collaborate and share multiple documents and related works to be incorporated into one cohesive final project. Finally, the current art lacks a simple and straightforward way for an unsophisticated user to publish a finalized professional-looking project that is sold in various online stores and in the proper format for the myriad of electronic devices used by today's consumer.

Therefore, there is a need in the art for a collaborative system and method for publishing multi-media interactive content to be used by non-professional publishers and self-publishers such as educators, instructors, school or college students, consultants, thought leaders, to create multimedia documents that can be viewed and played on any web-enabled device, computers, tablets, or high res smart phones. These and other features and advantages of the present invention will be explained and will become obvious to one skilled in the art through the summary of the invention that follows.

### SUMMARY OF THE INVENTION

Accordingly, it is an object of the present invention to allow users of a computer, smart-phone, tablet, mobile device or other computing device to create, collaborate, and publish multimedia documents and electronic online books. This system and methods described herein give any user with basic computer skills the ability to collect documents and publish them in online books and eBooks, without requiring knowledge of eBook publishing or skills in book layout.

According to an embodiment of the present invention, a system for the collaborative publication of interactive multimedia content is provided, the system including an eBook creator module comprising physical memory storing instructions that cause the project initialization module to; provide a user interface to a user; receive a initialization request from said user; present one or more pre-built book cover templates to said user; receive a book cover selection from said user; wherein said book cover selection is chosen from said one or more pre-built book cover templates; present one or more document page templates to said user; receive a document page template selection from said user, wherein said document page template selection is chosen from said one or more document page templates; present one or more book navigation methods to said user; receive a book navigation method selection from said user, wherein said book navigation selection method selection is chosen from said one or more book navigation methods; provide said user with a document manager module, wherein said document manager module is configured to allow said user to create and edit book content; provide said user with an eBook manager module, wherein said eBook manager module is configured to create an electronic online book comprising of said book cover selection, said document page template selection, said navigation method selection, and said book content; and publish said electronic online book, wherein said online book is distributed through online bookstores.

According to an embodiment of the present invention, the eBook creator module may be utilized by a plurality of users simultaneously.

According to an embodiment of the present invention, the plurality of users can contribute collectively to said book content.

According to an embodiment of the present invention, the system further includes a canvas editor; wherein said canvas editor allows said user to create and incorporate one or more elements from the group comprising drawings, sketches, handwriting, diagrams, images, formulas into said book content.

According to an embodiment of the present invention, the canvas editor allows the user reading book content to play, pause, and stop a step-by-step animation of the canvas elements and to insert add-on content to existing book content, said add-on content being accessible only to said user.

According to an embodiment of the present invention, the add-on content is further accessible to one or more of a document author and a limited number of secondary users, wherein said secondary users are first given access privileges by said user.

According to an embodiment of the present invention, the system further includes a document editor; wherein said document editor allows said user to create any number of properly formatted sections comprising of rich text, images, video, canvas, and other public media or web pages available from other web sites .

According to an embodiment of the present invention, the system further includes an accounts manager module; wherein said accounts manager module controls said user's account access, preferences, and privileges.

According to an embodiment of the present invention, the system further includes a configuration manager, wherein said configuration manager offers said user an ability to designate properties of said document as required or optional.

According to an embodiment of the present invention, the system further includes a communications means, wherein said communications means allows said eBook creator module to utilize a computer network.

According to an embodiment of the present invention, the system further includes a data store, wherein said data store comprises templates, files, formulas, and settings that are utilized by said eBook creator module.

According to an embodiment of the present invention, a computer implemented method for the collaborative publication of interactive multi-media content includes the steps of: providing a user interface to a user; receiving a initialization request from said user; presenting one or more pre-built book cover templates to said user; receiving a book cover selection from said user; wherein said book cover selection is chosen from said one or more pre-built book cover templates; presenting one or more document page templates to said user; receiving a document page template selection from said user, wherein said document template selection is chosen from said one or more document page templates; presenting one or more book navigation methods to said user; receiving a book navigation method selection from said user, wherein said book navigation selection method selection is chosen from said one or more book navigation methods; providing said user with a document manager module, wherein said document manager module is configured to allow said user to create and edit book content; providing said user with an eBook manager module, wherein said eBook manager module is configured to create a book comprising of said book cover selection, said document page template selection, said navigation method selection, and said book content; and publishing said electronic online book, wherein said online book is distributed through online bookstores.

According to an embodiment of the present invention, the method further includes the step of sharing said book with a group, wherein said group can edit and contribute said book content to said book.

According to an embodiment of the present invention, the method further includes the step of distributing said book; wherein said book is distributed for monetary compensation.

According to an embodiment of the present invention, the method further includes the step of incorporating one or more elements from the group comprising drawings, sketches, handwriting, images, diagrams and formula, via a canvas editor, into said book content.

According to an embodiment of the present invention, the method further includes the steps of: playing a step-by-step animation of the canvas elements; stopping said step-by-step animation of the canvas elements; pausing said step-by-step animation of the canvas elements; and inserting add-on content to existing book content, via a canvas editor, said add-on content being accessible only to said user.

According to an embodiment of the present invention, the add-on content is further accessible to one or more of an original author of a document, and a limited number of secondary users, wherein said secondary users are first given access privileges by said user.

According to an embodiment of the present invention, the method further includes comprising the step of creating properly formatted sections for said document, via a document editor and comprising of rich text, images, canvas, video, and other public media or web pages available from external web sites.

According to an embodiment of the present invention, the method further includes the step of a document author allowing other users create derived content from an original document and then automatically collating said derived content with original document in chapters of ebook.

### BRIEF DESCRIPTION OF THE DRAWINGS

FIG. 1 shows how remote users at computers, mobile devices or partner web sites interact with the systems and methods described herein and each of the applications embodied by the new service;

FIG. 2 shows a flow-chart of a method used by co-authors to create, collaborate, and publish new books and ebooks, in accordance with an embodiment of the present invention;

FIG. 3 shows data elements required to create the book framework, in accordance with an embodiment of the present invention;

FIG. 4 shows options to share book with public and other members, in accordance with an embodiment of the present invention;

FIG. 5 shows a book organizer for adding and sorting documents to online book, in accordance with an embodiment of the present invention;

FIG. 6 shows a diagram of how a table of contents is created, in accordance with an embodiment of the present invention;

FIG. 7 shows a flow-chart of a user's actions supported in navigating a book, in accordance with an embodiment of the present invention;

FIG. 8 shows options for publishing a book as an eBook, in accordance with an embodiment of the present invention;

FIG. 9 shows a flow-chart of a convert method that transforms an online book into an eBook, in accordance with an embodiment of the present invention;

FIG. 10 shows an example of an eBook generated in accordance with an embodiment of the present invention;

FIG. 11 shows an example of an eBook generated in accordance with an embodiment of the present invention;

FIG. 12 shows an example of an eBook generated in accordance with an embodiment of the present invention;

FIG. 13 shows an example of an eBook generated in accordance with an embodiment of the present invention;

FIG. 14 shows an example of an eBook generated in accordance with an embodiment of the present invention;

FIG. 15 shows an example of an eBook generated in accordance with an embodiment of the present invention;

FIG. 16 shows a diagram of Organizations in accordance with an embodiment of the present invention;

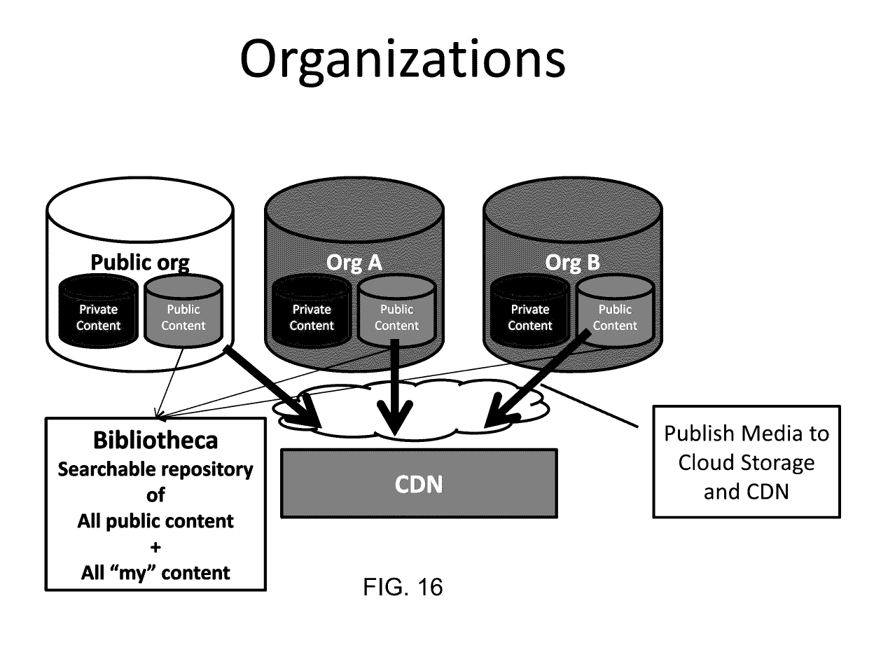

FIG. 17 shows a diagram of Groups and Users within Organizations in accordance with an embodiment of the present invention;

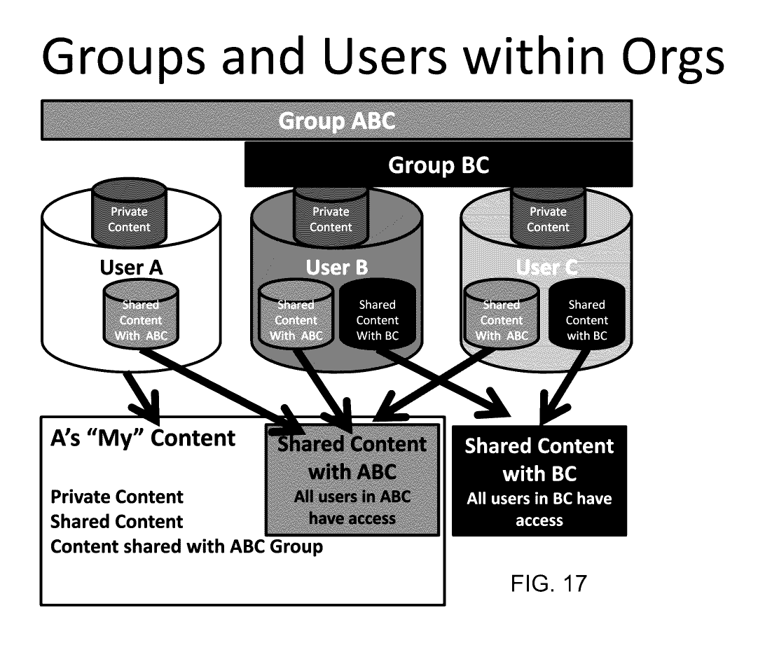

FIG. 18 shows a diagram of the sections, documents, and books of multiple users in accordance with an embodiment of the present invention;

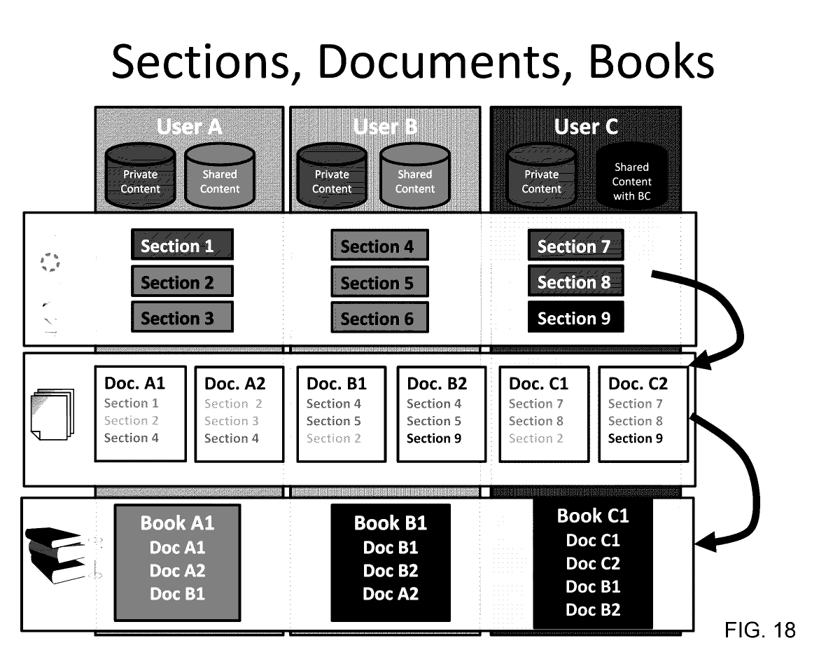

FIG. 19 shows the Document Editor without sections in accordance with an embodiment of the present invention;

FIG. 19B shows a Document Editor in accordance with an embodiment of the present invention;

FIG. 20 shows the Document Editor with sections in accordance with an embodiment of the present invention;

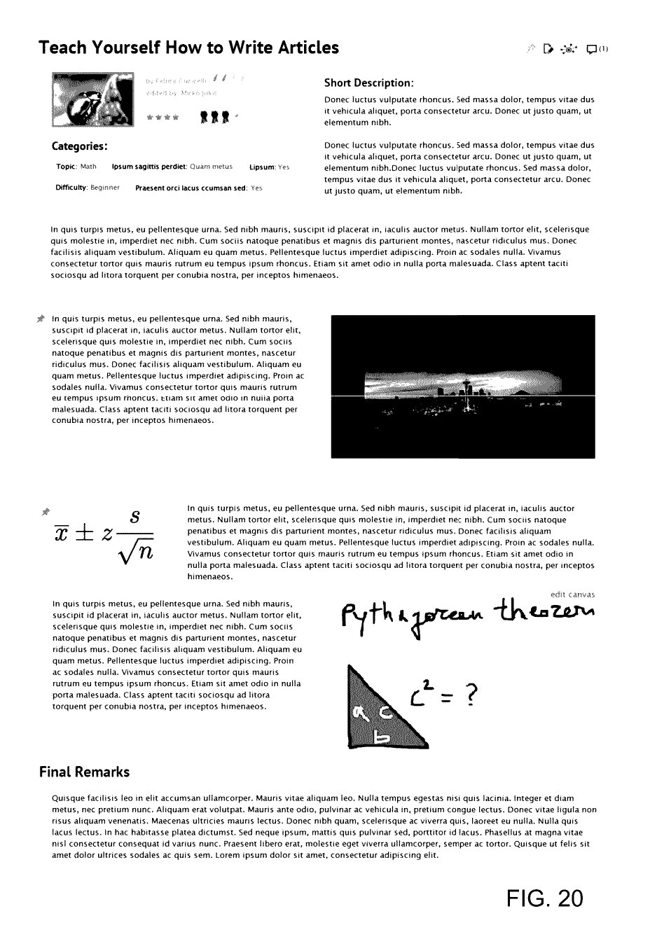

FIG. 21 shows the Document Viewer in accordance with an embodiment of the present invention;

FIG. 22 shows the Canvas Editor in accordance with an embodiment of the present invention.

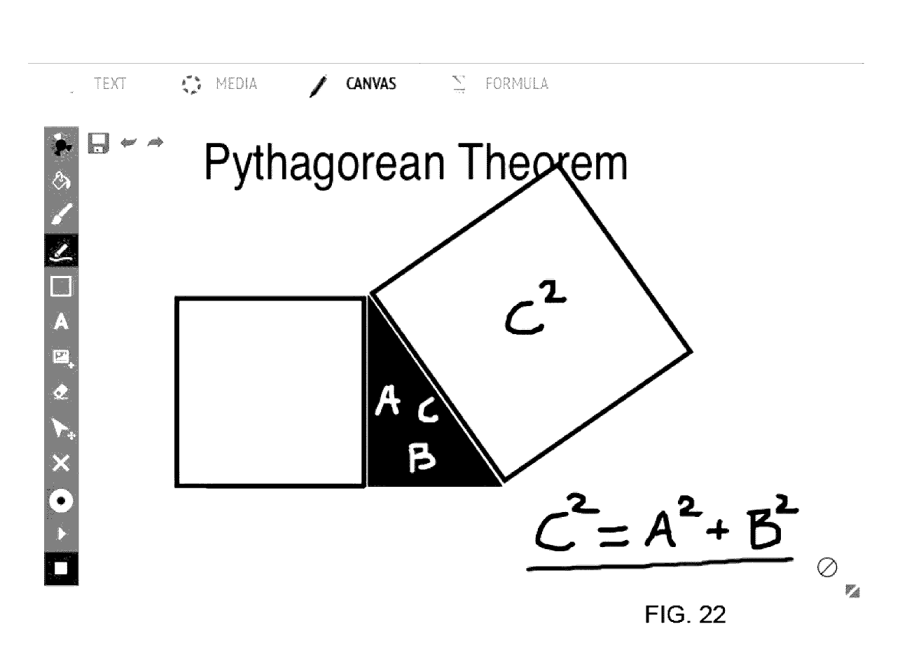

FIG. 23 shows Derived Documents screen in accordance with an embodiment of the present invention.

FIG. 24 shows a specific Related Document in accordance with an embodiment of the present invention.

FIG. 25 shows an original document incorporating two canvas sections in accordance with an embodiment of the present invention.

FIG. 26 shows a document incorporating add-on content in two canvas sections in accordance with an embodiment of the present invention.

FIG. 27 shows all add-on content to a document accessible to original document author in accordance with an embodiment of the present invention.

FIG. 28 shows the same document as a dynamic interactive eBook page in accordance with an embodiment of the present invention.

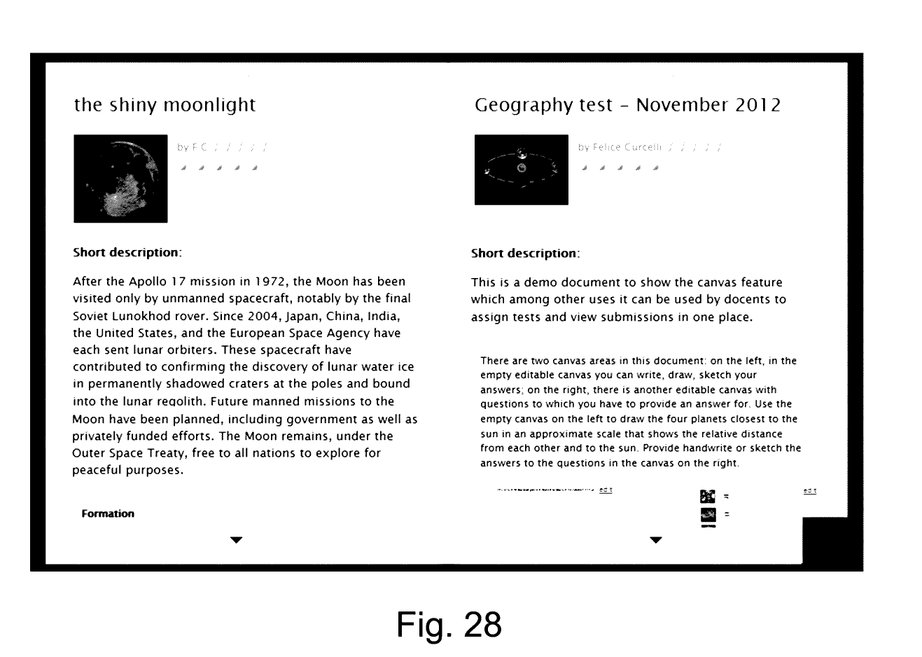

FIG. 29 shows the same document as viewed by an eBook user and incorporating user's own add-on content in accordance with an embodiment of the present invention.

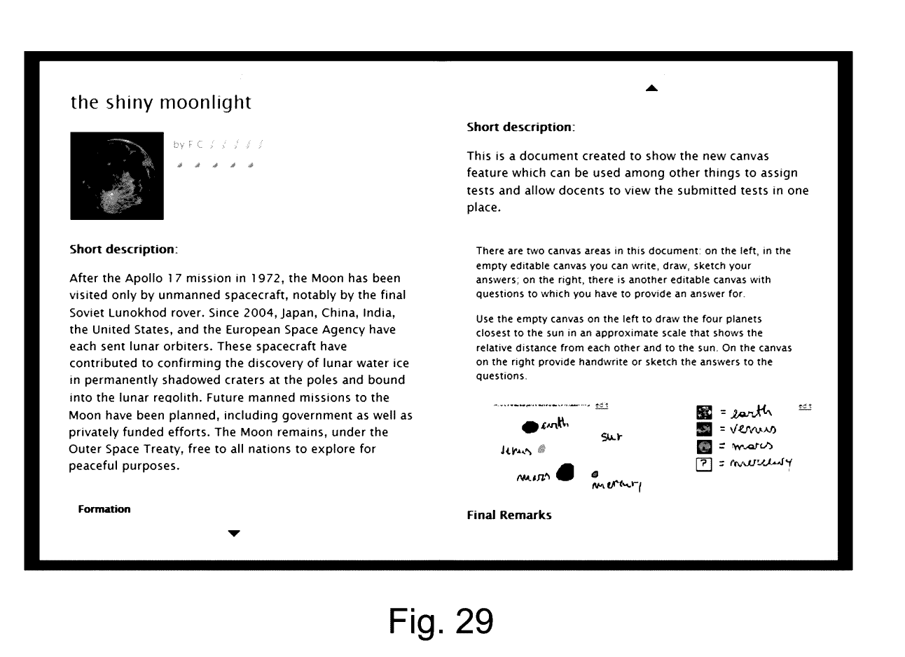

### DETAILED SPECIFICATION

The present invention generally relates to the automation of generating online books, as collection of documents, and specifically eBooks. Specifically, this invention relates to a system and method for allowing multiple users, without any particular knowledge of publishing or computer systems, to collaborate over one or more networks and generate multimedia documents and ebooks.

According to an embodiment of the present invention, the method described here specifies a document creation method and editor targeted at non-professional publishers to professionally lay out documents including text and multi-media elements, such as videos, photos, canvas, and animations, that can be included in eBooks. In a preferred embodiment, the method also introduces a separate Canvas Editor which allows publishers to incorporate multi-media components, such as i) a canvas for drawing, sketching and handwriting, ii) animated demonstrations of how to build a specific drawing or diagram, or iii) a diagram showing a sequence of steps into their documents and in the eBooks that include those documents. One of ordinary skill in the art would appreciate that the Canvas Editor could be used to incorporate any variety of multi-media forms into a document, and embodiments of the present invention are contemplated for use with any such multi-media forms.

According to an embodiment of the present invention, the method defines the layout of a document editor that allows non-professional users create multimedia documents, including animations for gaming, education, instructional information. In a preferred embodiment, the method requires no coding experience or document publishing experience, but only basic web navigation, text authoring, and web search skills.

According to an embodiment of the present invention, the method also defines how to create and embed interactive elements such as canvas; readers can save their own canvas drawings along with document without disrupting original format and layout of the document.

According to an embodiment of the present invention, one application of the method is for school projects where a teacher creates a multimedia document that include not only text and pictures but also animations explaining concepts in a step-by-step fashion. Similarly, teacher can use same documents to ask students to create their own animations or complete existing animations for testing or simply to reinforce the understanding of the concepts explained.

According to an embodiment of the present invention, the new process helps the user, professional publisher, or groups of users, monetize their efforts through the publishing of their documents and eBooks by setting prices or accepting donations.

According to an embodiment of the present invention, the systems and methods herein described may be implemented, for example, via a ‘web site’.

According to an embodiment of the present invention, the systems and methods herein described may be implemented through a web-based service that allows publisher-consumer users collaborate to create multimedia documents and books for publishing on the web and/or to eBook stores. For example, a teacher communicating a lesson plan to his students, from which students can derive outlines and explanation of assignments and then get feedback and annotations from teachers on the completed projects, i.e. documents, online book or ebook.

According to an embodiment of the present invention, there are at least four embodiments of the invention that build on each other and work together.

According to an embodiment of the present invention, the invention gives publishers of content, e.g. teachers and professional authors, the ability to incorporate animations and canvas in their documents, and therefore online books and ebooks, to create more engaging and interactive learning experiences and entertainment without the aid of professional computer experts.

According to an embodiment of the present invention, the invention gives users the ability to search documents and sections of documents, with sections representing the basic units of documents and consisting of textual content as well as multimedia and canvas content, and give users ability to add other user's documents as favorite documents to an online private library. Then incorporate said sections from private library into new documents thus encouraging re-usability and crowd-sourcing of new documents.

According to an embodiment of the present invention, the invention gives users with no knowledge of web or eBook publishing, nor book layout skills, the ability to create and publish online books and eBooks of documents in few simple steps: selecting one of pre-built templates for the book cover and one for document pages; selecting which table of contents and book navigation methods to generate; optionally sharing the book with friends and colleagues by allowing each one to contribute to the book with own documents or favorite documents; setting a price or accept donations; then choosing the distribution methods, i.e. through a web site or online eBook stores. The process automatically creates the specified tables of content, navigation to specific sections, plus incorporates interactive features and multi-media support, such as video streaming and annotations. The conversion method generates the standard ePub format for eBook distribution and retains the interactivity of the corresponding online book.

According to an embodiment of the present invention, the invention gives users the ability to aggregate documents in daily homework and lesson plans.

Document Editor

According to an embodiment of the present invention, documents are made of some predefined fields including, but not limited to, title, categories, a brief description, final remarks, and one or multiple sections which make up the main body of the documents. One of ordinary skill in the art would appreciate that there are many types of predefined fields that could be incorporated into the document editor, and embodiments of the present invention are contemplated for use with any such predefined fields.

According to an embodiment of the present invention, the editor allows users to create documents with an infinite number of sections. four section types that might be commonly used are text, media, canvas, and formula. One of ordinary skill in the art would appreciate that there are many sections that could be added to a document, and embodiments of the present invention are contemplated for use with any section type.

According to an embodiment of the present invention, text and formula sections include existing art for formatting and creating text and formula within document.

According to an embodiment of the present invention, media sections include media files such as photos and videos.

According to an embodiment of the present invention, canvas sections include static drawings, animated drawings, and editable drawings. Editable drawings give readers the ability to modify document's initial canvas drawing.

According to an embodiment of the present invention, documents are a sequence of sections laid out in document and eBook pages according to author's intended layout which consists of choosing four possible options for laying out each section. In a preferred embodiment, authors can save sections, text, formula, and media to a reserved area of a data store feeding the document editor.

According to an embodiment of the present invention, when creating new documents, authors can re-use previously created sections and media from the reserved area of the data store, or those from other users whom have shared their documents with author.

According to an embodiment of the present invention, a user has numerous options that may be utilized as sources of sections and media in document. In a preferred embodiment, a user may obtain sections and media from sources that include, but are not limited to, files stored locally on their computing device, files stored in the data store, or files from the internet in general. One of ordinary skill in the art would appreciate that there are many sources that might be capable of providing sections and media to a user, and embodiments of the present invention are contemplated for use with any such source.

According to an embodiment of the present invention, a user may be able to add identification information to a document. In a preferred embodiment, meta-data fields and categories allow author to uniquely identify a document as well as categorize it for search purposes. Categories are custom defined by the organization which an individual belongs to by creating own set of classification categories which are then available to the organization users in the document editor.

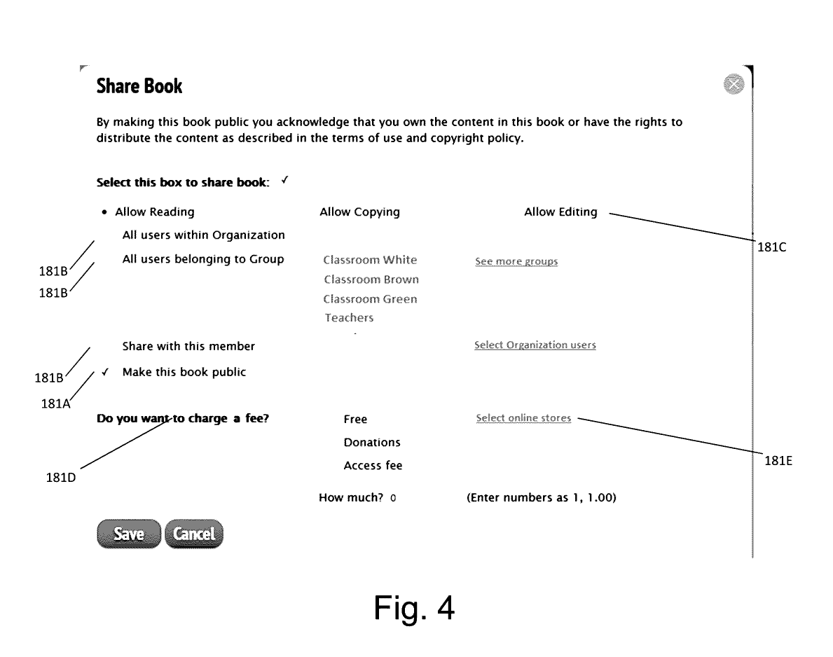

According to an embodiment of the present invention, authors can share individual documents or entire books with a group of self-selected users or with a group defined by an organization admin. In a preferred embodiment, the members or groups may be granted varying levels of access to a given document including simple view only access, view and copy access, or full access where a group or member can modify the various document sections. FIG. 4.

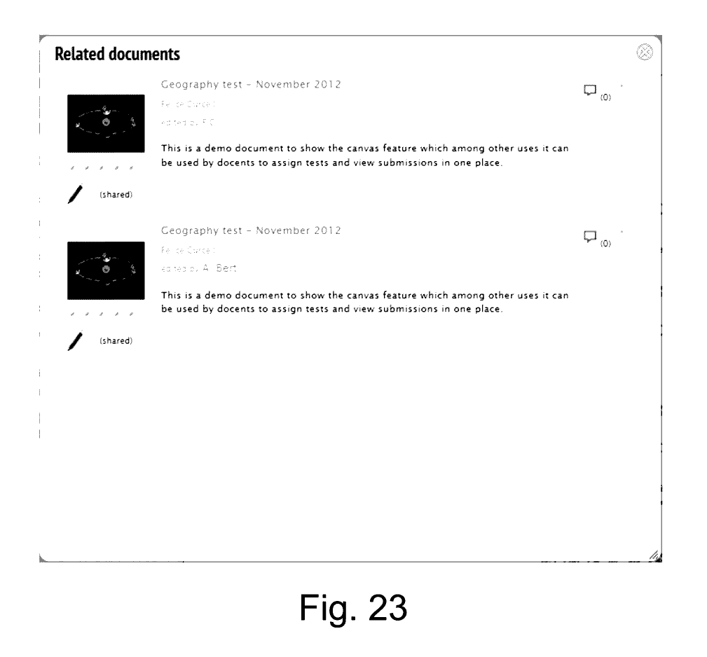

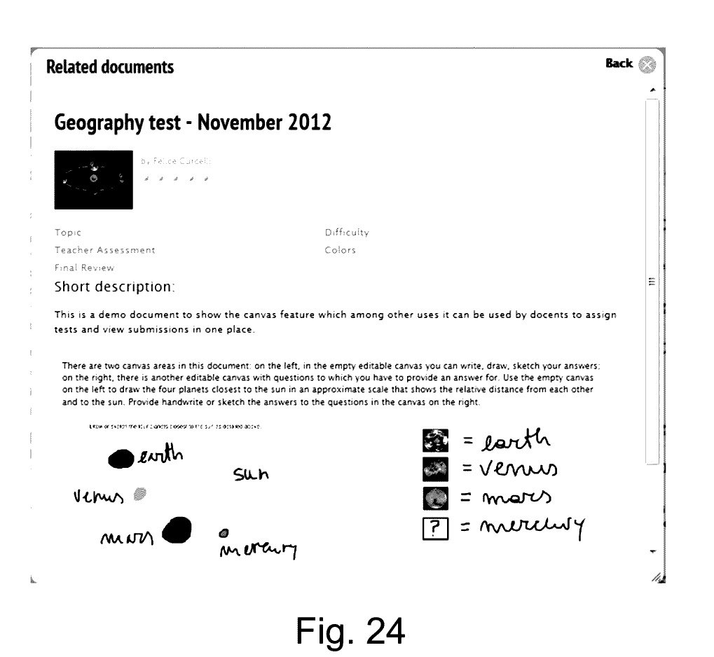

According to an embodiment of the present invention, the method also allows an author to view all copies of their own documents. As an illustrative example, a teacher could instruct the classroom students to copy a teacher document and expand on the concepts introduced in the original document for an assignment or test. The teacher could then view all the documents that are submitted by the students directly from the original document unless students choose to restrict access to their document copy. FIG. 23, FIG. 24.

According to an embodiment of the present invention, the readers of document may be able to add private annotations to document and each section therein. In a preferred embodiment, the reader may then be able to choose to share the private annotations with the author of the document. As an illustrative example, this could be used by students for instance to ask questions to teacher regarding a topic introduced in document. Alternatively, it could be used by teachers to ask students to submit answers to questions posed in teacher's document.

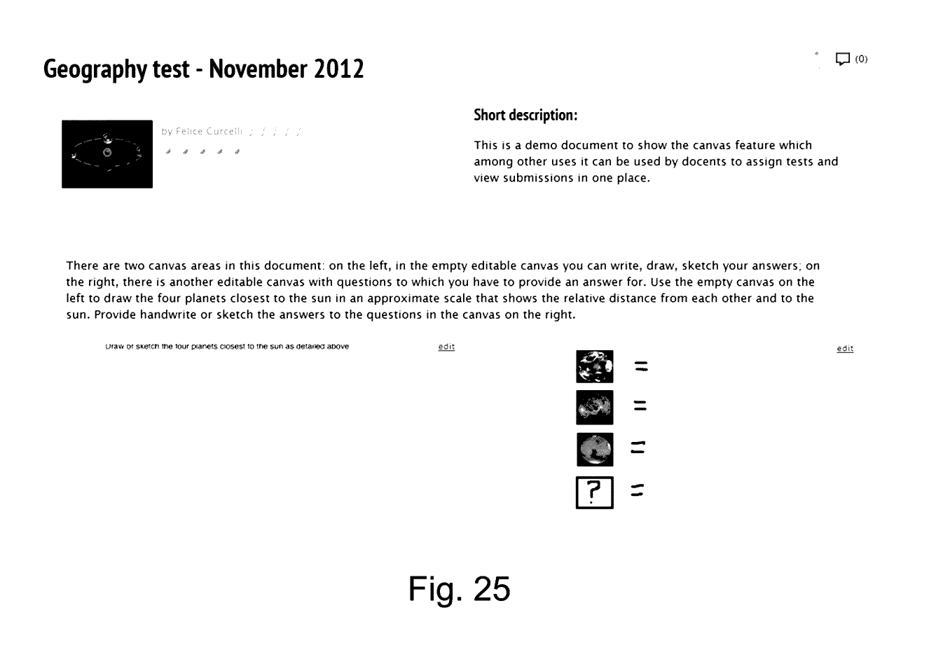

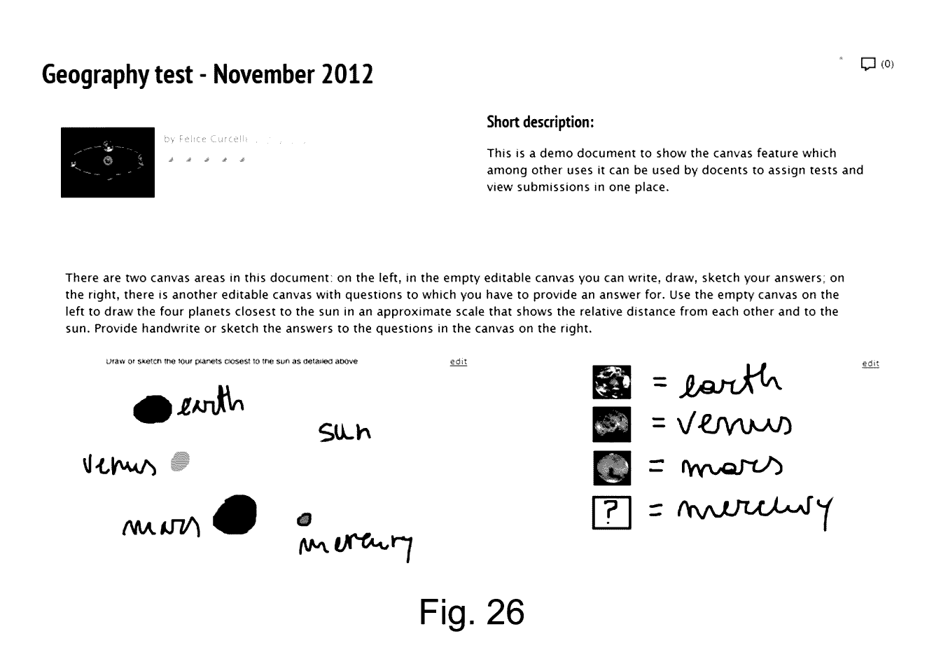

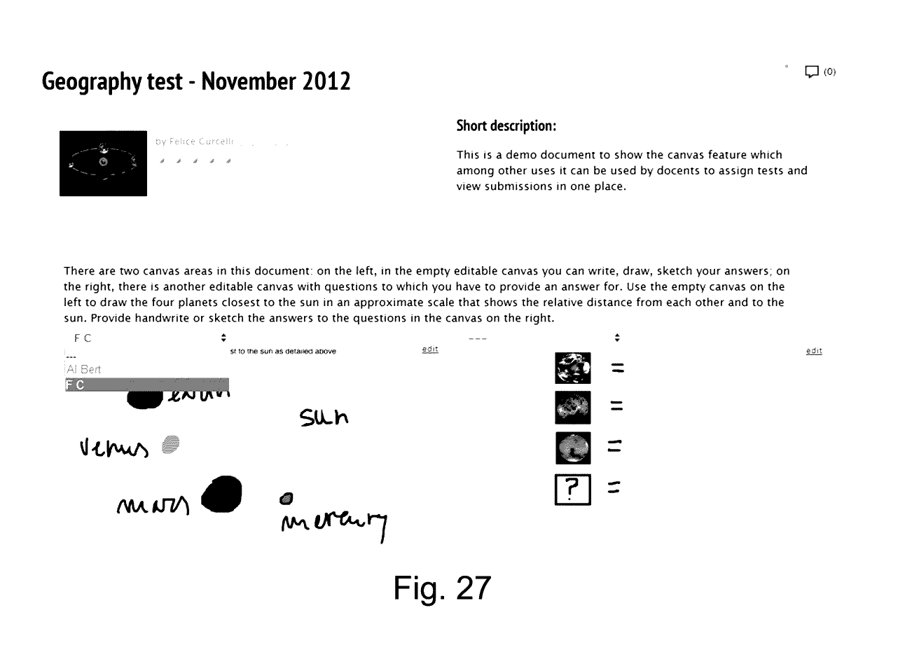

According to an embodiment of the present invention, readers of a document with canvas media may modify the canvas media and save the modified canvas without changing the original canvas or document. FIG. 25, FIG. 26. In a preferred embodiment, the author of document may then view all saved canvas associated with that document. FIG. 27.

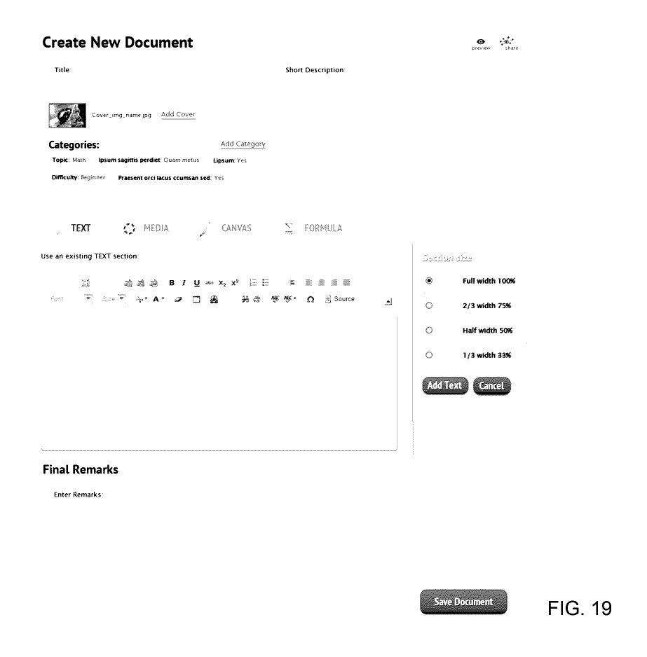

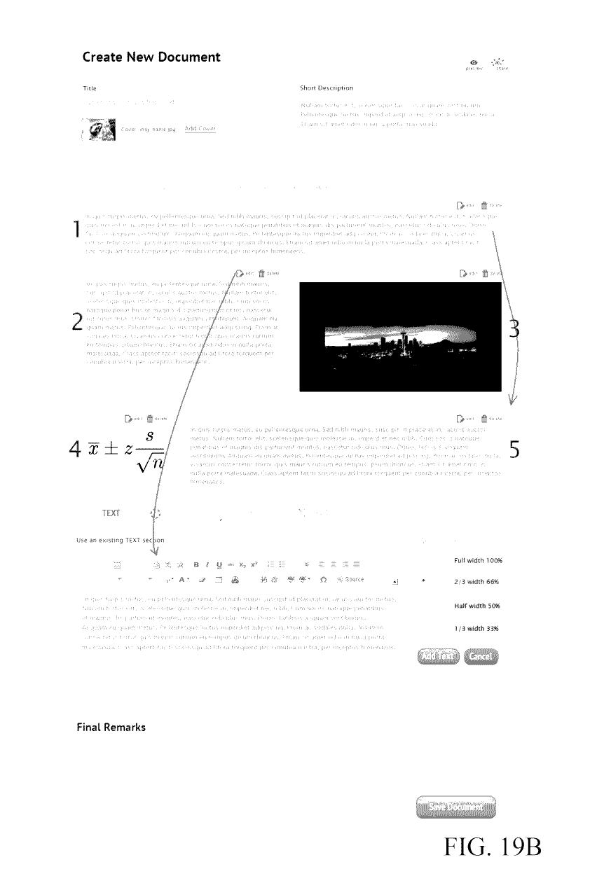

According to an embodiment of the present invention, the user can choose the alignment and width of each section. FIG. 19.

According to an embodiment of the present invention, the document sections can be rearranged very simply by dragging them to the desired location within the document. FIG. 19B

According to an embodiment of the present invention, when an author saves a section in document the section appears in read only mode (in document editor) with an edit icon next to it. Below the saved section a new control allows user to add a new section: text, formula, canvas, or media. The new control lets user specify the size, i.e. full width, ⅔, ½ width, and ⅓ width. If not full width text and media will be laid out side-by-side. The editor automatically complements the section following a part-width section with the proper width; so if a section width is ⅔, the section that follows will automatically get ⅓ of width. FIG. 19B.

According to an embodiment of the present invention, the text section edit controls (the icons on top of the field) will include an icon to add math formulas; when clicked it will expand the icons to include formula edit icons. In a preferred embodiment, the formula section has only edit controls for creating/editing a math formula.

According to an embodiment of the present invention, the media section allows user to upload/specify new media or drag/select media from reserved area in data store.

According to an embodiment of the present invention, an author can choose how to share a document; leave it private, share with public, share with the organization author belongs to or with a group. When sharing a document, an author can choose to share that document with groups he belongs to or groups he created himself, public groups or groups within an author's organization. An organization could be a school, a group could be a classroom of students. With private documents all sections of documents are private. When sharing a document, an author has the ability to share access to individual sections of the document or the entire document. When no privacy selection is made, sections in documents will inherit the same general access privileges of the hosting document. FIG. 4.

According to an embodiment of the present invention, when User A has copy access to a User B document, User A can copy that document. In a preferred embodiment, the document copy is created as private to User A, however User B (original author) can view it. Additionally, User B can see all copies of its original document by clicking a hyperlink in the document viewer. FIG. 23.

According to an embodiment of the present invention, readers of the documents can annotate document or individual sections therein with private notes. In a preferred embodiment, annotations on someone else's document are private to the reader, but the reader can choose to share private annotations with document author. Additionally, the document author can view all private annotations, including their own and those of other readers' who chose to share theirs. Readers, however, can only view their own annotations.

Canvas Editor

According to an embodiment of the present invention, the canvas editor provides a canvas where user can hand write text, shapes, draw and color lines and shapes, or select from predefined set of shapes. In a preferred embodiment, the canvas editor is similar to other drawing and charting programs but with few new important features, including the ability to 1) record the actions, strokes, shapes drawn in the canvas, 2) add one or multiple background images which could be previously created images from canvas, photos, maps, etc., or 3) add a background image as a transparent layer; for example, two different drawings when overlaid on each other produce a new drawing that is the combination of the prior ones. The same can be accomplished with photos.

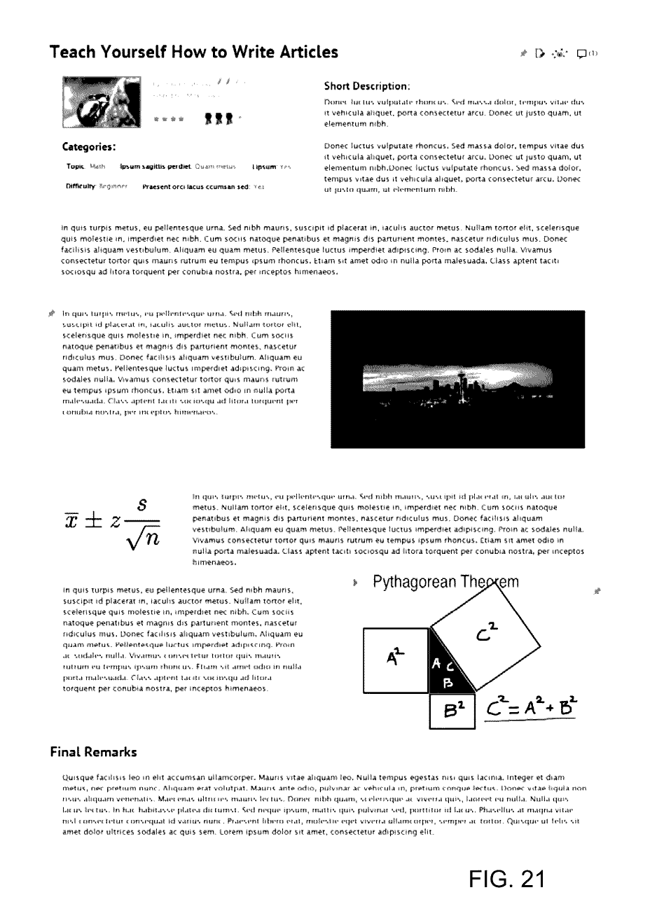

According to an embodiment of the present invention, an author can save canvas at any time as a static image and then continue recording to then playback animated sequence of steps. When a canvas section is included in a document and document added to ebook, the recorded animation is played automatically. A viewer can pause, rewind, or restart while viewing recorded animation. FIG. 21.

According to an embodiment of the present invention, canvas can be saved as animation, image, or as canvas. By saving it as a canvas it allows viewer of the canvas document or canvas section embedded in document to benefit from the canvas editor as well, with the ability to add upon the author's original drawings, sketches, etc. in canvas. Including it as an animation instead viewer of the document will see it as such and be able to pause/rewind/restart but not change or add upon the drawing. Lastly an author can save snapshots of canvas to save as a static drawing.

Canvas Sections In Documents

According to an embodiment of the present invention, canvas media can be saved as a read-only animation or as a paintable canvas.

According to an embodiment of the present invention, a read-only animation shows the step by step process of a methodology or concept. This could be an animation of how to assemble a piece of furniture, how to fix a household appliance, show the demonstration of a theorem. The ability of user to pause/rewind/restart animation gives user the ability to work along the provided information.

According to an embodiment of the present invention, a Paintable Canvas consists of an unfinished animation or a static image, over which the viewer can draw and write own steps to complete animation or drawing. Paintable canvas could be used for examples for tests where pupils are given some preliminary information over which they can fill in the ‘gaps’ simply using the natural touch-based interface, drawing and handwriting of the canvas.

According to an embodiment of the present invention, when a viewer of document draws or writes in the paintable canvas section, the canvas is saved in a separate sub-canvas section of the document. The set of all sub-canvases saved with a document is referred as a sub-canvas set. The sub-canvas set is saved with the original document and accessible only to the document author and each sub-canvas in set by the sub-canvas author.

According to an embodiment of the present invention, the sub-canvas sets allow the original document to remain intact, so that subsequent visits to the document or eBook page retain the author's intended experience, look & feel and content, to new visitors. A typical application of sub-canvas is for a teacher to see the step-by-step completion of a test or exercise included in a document or eBook page from all the students taking or participating in the test.

According to an embodiment of the present invention, an alternative to using sub-canvas is allowing users to make a copy of the original document. A document author must enable copy access when sharing document to the group or organization. If copy is allowed, then all copies of the document are linked to original document and accessible to original author.

According to an embodiment of the present invention, a document author can include multiple sections in a document, including multiple canvas sections and therefore multiple sub-canvas sets.

According to an embodiment of the present invention, the method of linking original documents to copies and sub-canvas sets and the ability of embedding sections in a document authored by multiple users, in conjunction with the permissions -based access control, represents a novel aspect of the new collaboration workflow envisioned in this new method.

Using Canvas to Create Animations

According to an embodiment of the present invention, images, videos, and animations can be used to enrich and simplify the learning process of complex tasks or concepts and included in documents and ebooks. While creating images and videos is a well known art and skill mastered by many, creating animations instead requires more advanced skills.

According to an embodiment of the present invention, creating even simple animations in the current art requires professional skills including page design and layout skills and programming in a specialized programming language. An alternative for creating animations is creating ‘slide shows’. Both methods are time consuming and requiring specialized skills; the slide shows while commonly used today is also poorly designed to fit in the context of interactive documents and eBooks, requires expensive software on user's desktop, and does not render equally well, or at all, across different type of devices, laptops, tablets, smartphones.

According to an embodiment of the present invention, the new method introduced here is to give non-professional users, not skilled in any particular tool, the ability to create animations very simply. The user only needs to become familiar with the few actions available in canvas editor, that are similar to a drawing program, and that is available as a web service and therefore requiring no special downloads.

According to an embodiment of the present invention, a user can choose to record all or some of the actions occurring in the canvas. The sequence of actions makes up the animation. In a preferred embodiment, authors may create animations by simply recording all sketching, drawing, writing, coloring, resizing, and rotating actions that occur in a canvas element of the document.

According to an embodiment of the present invention, an author can use their preferred interne connected device, such as laptop or tablet, to author documents, animations and ebooks.

Implementation Details

According to an embodiment of the present invention, the rendering and recording of a canvas is based on the computation of coordinates as user moves pointer, finger, or pen around in the canvas to draw or handwrite.

According to an embodiment of the present invention, a canvas is really a dynamic image which a browser creates dynamically, based on the coordinate values, therefore this rendering takes some time. This poses a challenge when rendering and recording handwriting because even milliseconds of delay in the render logic can make user experience unacceptable, i.e. too slow.

According to an embodiment of the present invention, another “speed problem” is that the browser's mouse/touch move events are not triggered in the browser on every coordinate change. Depending on browser (and possibly system), events are triggered with some delays, sometimes in the order of seconds. Therefore, when moving on the canvas slowly, the canvas can detect x:y coordinate changes more accurately. Moving more quickly, however, the distances between x:y and next x:y coordinate (when event is triggered) could be up to 25 pixel, creating visible gaps in the rendering of the lines or handwriting.

According to an embodiment of the present invention, the method estimates the actual movements and ‘connects the dots’ to overcome the ‘gaps’ issue. Connecting the dots, however, will not be exact and cause lines to be slightly scattered and uneven. To compensate for these inaccuracies the lines are smoothed as soon as a ‘finger up’ event is triggered. Smoothing of the lines is staggered between these events, not done on the fly (i.e. real time) while user draws the lines because the required computation would increase the delays between events.

File Sizes

One of the issues in recording animations, as it is for videos, is that file sizes can increase dramatically. In individual documents, downloading and rendering animations within a document, file size may not be a concern, with the exception of users accessing the document through slow internet connections. The file size issue however becomes much more severe for long animations or when downloading eBooks, that is eBooks containing many documents with animated canvas.

According to an embodiment of the present invention, when an eBook file is downloaded to a tablet device, downloading and opening such ebooks could be an issue because files could easily reach 100 MB+ in size.

According to an embodiment of the present invention, similar to video compression, animations are compressed but with a loss-less algorithm. When recording an animation the method optimizes the space utilization by ‘discarding’ pauses (no information) in the movements. This is because as opposed to videos a pause does not carry ‘information’, in a video it usually does. What this means is that an animation lasting 20 minutes with 15 minutes of pauses has the approximate size of an animation 5 minutes long.

According to an embodiment of the present invention, an author can add pauses in the animation using the canvas ‘pause’ action control.

### Exemplary Embodiments

Instructional Interactive ebooks

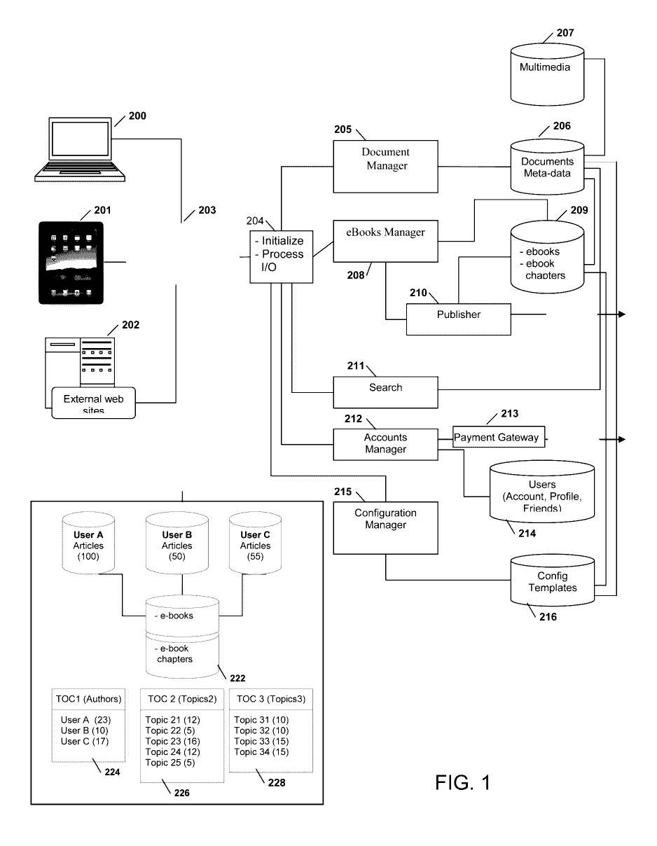

According to an embodiment of the present invention, the process and methods of this invention can be applied to create a generic process as shown in FIG. 1, referenced above as Instructional Interactive eBooks, This new process allows users with basic computer skills create, collect, organize documents in electronic online books and eBooks. This new process allows users of the system to collaborate in the creation of the online books with each user contributing own or favorite documents; the process includes a conversion method where the online book is converted to the eBook format and a publishing method allowing users to distribute the newly eBook through online eBook stores. Interactivity in the eBooks comes from playing media, canvas elements, and animations incorporated in eBooks as well as being able to personalize the reader experience; for instance, instructional eBooks could allow user change the skill level to get different level of details on the instructions.

Turning now to FIG. 1, a schematic overview of a system in accordance with an embodiment of the present invention is shown. While the embodiment shown in FIG. 1 is an exemplary embodiment, other embodiments may include additional or fewer components. One of ordinary skill in the art would appreciate that there are numerous configurations of the components that could be utilized with embodiments of the present invention, and embodiments of the present invention are contemplated for use with any configuration of components.

According to an embodiment of the present invention, a user of a remote device, computer 200 or a smart phone 201, or a partner web site 202, can access a service implementing the invention through the internet 203. An exemplary embodiment of the present invention is defined in the following paragraphs.

According to an embodiment of the present invention, a method 204 is provided that reads user's profile 214, if user is registered with service, authenticates user, initializes session, and processes all input and output from and to users at remote devices 200, 201, and 202. Users 200 would interact with 204 through a web browser, user on a mobile device 201 would interact with a local app and local app would interact with method 204 through web-based REST-like API services. Partner web sites 202 would interact with method 204 through web-based REST-like API services.

According to an embodiment of the present invention, an initialization method 204 may also be utilized to determine user preferences, i.e. level of experience or skills or preferred language, based on user profile in 214, and using the services of the accounts manager module 212.

According to an embodiment of the present invention, a document manager module 205 is provided that allows users to create documents using an html text editor, prior art, or import documents from other sources, using copy/paste, or by providing a URL and selecting a standard native format, XML, HTML or XHTML based, to use in the import process.

According to an embodiment of the present invention, methods in module 205 are presented to users for providing a title to the document, a brief introduction, and content, select predefined document properties or custom properties stored with document as meta-data in 206 and defined in config data store 216. A predefined property could be for instance the skill level required to read document or complete exercise. Additionally, user can upload images or photos and video associated with a document and stored in 207. Search and sort method 211 are provided to help users manage own documents and find and add other users' documents as favorite documents.

According to an embodiment of the present invention, the document manager 205 module separates the user's documents into own documents or favorite documents.

According to an embodiment of the present invention, the eBooks manager module 208 allows users to create and manage books created with the user's own or favorite documents. The eBooks manager module 208 allows a user create a book framework and invite other members of the service implementing the invention to contribute to the book content each with their own or favorite documents. The eBooks manager module 208 may also support a book framework composed of several pre-defined html templates stored in 216; user creator selects the ones to use for cover and document pages. Each template provides the frame and layout while the documents themselves provide the content. The book creation method in the eBooks manager module 208 merges the documents with the templates, substituting the pre-defined unique tags in templates with the actual content.

According to an embodiment of the present invention, a book organizer method of the eBooks manager module 208 allows users to add documents from user's own or favorite documents lists directly into the organizer by dragging said documents. Users can sort documents by dragging them to an exact location within the book organizer.

According to an embodiment of the present invention, the chapters of the book are built from the number and sequence of documents in the book, and based on document's meta-data. Meta-data is composed of default properties, such as document creation date, author, document type, or language, and custom document properties, such as skills required to read document. Such properties are created and managed through the configuration manager 215.

According to an embodiment of the present invention, services implementing this invention will differ on the type and number of default and custom document properties, because said properties are specific to the particular audience of the eBooks. For instance, the properties of documents in cookbooks, i.e. recipes, are course, cuisine, preparation time (cooking skill level), cooking time, nutrients, etc; while the properties for an instructional book on how to install TVs will have TV size, manufacturer, technology, technical skills level, etc.

According to an embodiment of the present invention, a configuration manager gives users the option to create new properties and designate them as required or optional. Required properties are those that require user creating a new document to provide or select a value for said properties before document can be saved to documents data store 206.

According to an embodiment of the present invention, eBooks manager module 208 gives user the ability to select which table of contents to generate automatically based on the available document properties.

According to an embodiment of the present invention, the book publisher 210 is responsible for the conversion of the online book into the eBook format. This consists of assembling and merging of templates with documents to generate the actual ePub archive file of text, images, canvas, and videos.

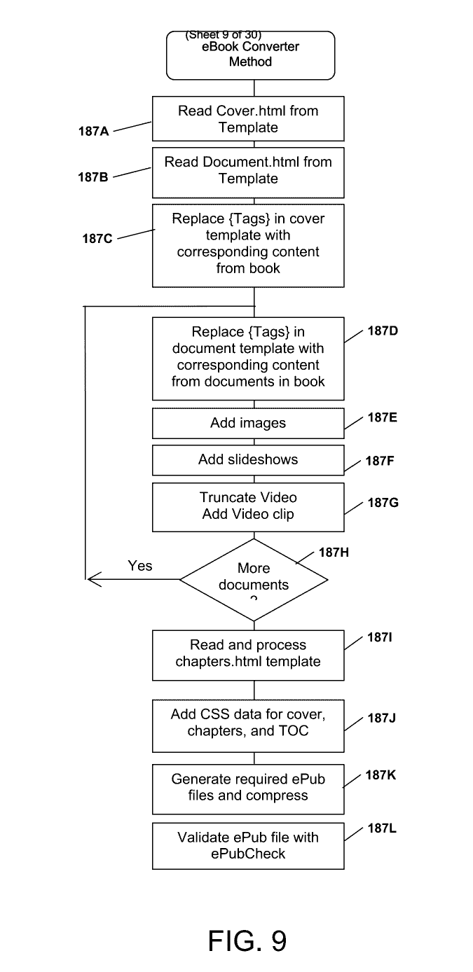

According to an embodiment of the present invention, the book workflow process for creating, sharing and collaborating, and publishing methods described in FIGS. 1-9 apply to this Instructional Interactive eBooks process as well. The ePub conversion method described in FIG. 9 applies to this Instructional Interactive eBooks process as well.

Books Manager

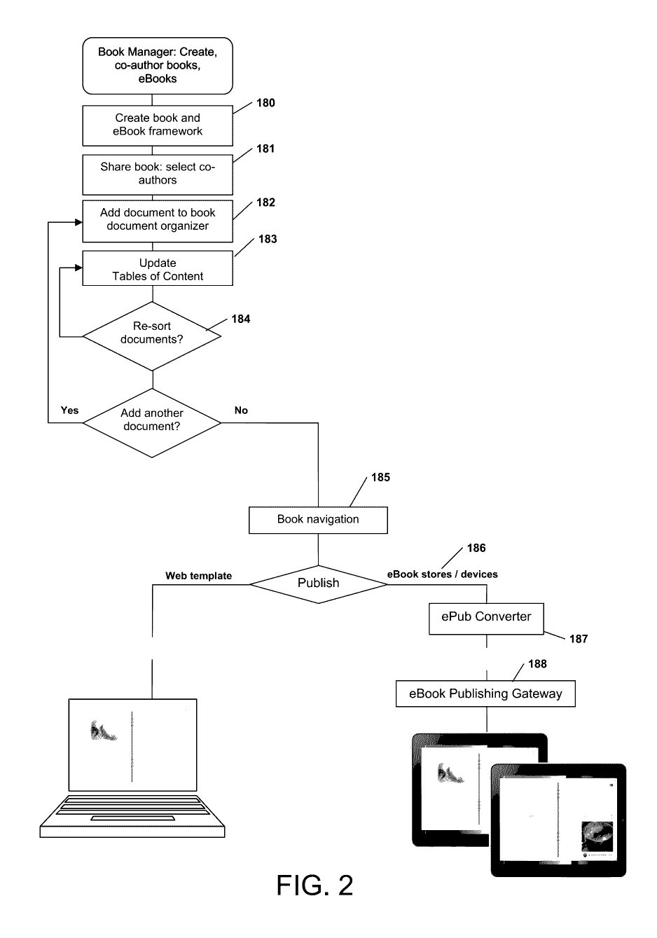

According to an embodiment of the present invention, the books manager detailed in FIG. 2 allows users with basic computer and web navigation skills to create collections of documents as electronic online books and eBooks.

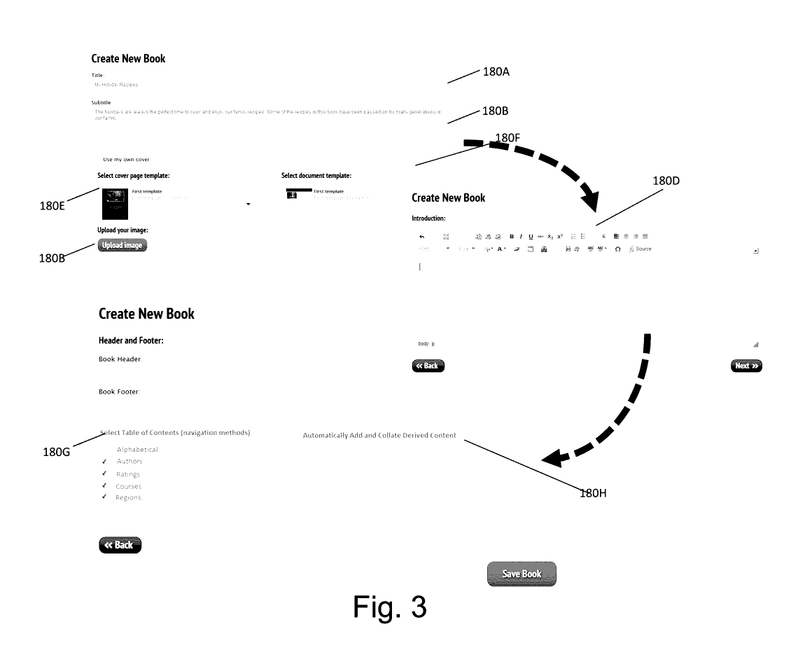

According to an embodiment of the present invention, the create books method 180 in FIG. 2 allows users to create a new book framework that will hold the actual content. The create book method is detailed in FIG. 3. The method allows user to specify a Title 180A, a brief introduction 180B, and cover page picture 180C. The author's name and 180A, 180B, and 180C will appear on the book's cover page in the layout defined by the selected cover page template 180E. The method provides user a rich text area field to store the book introduction which would appear before the table contents and after the bookcover page. The method also allows user to choose which tables of content to include with book 180G and a document page template 180F which will determine the layout of document pages.

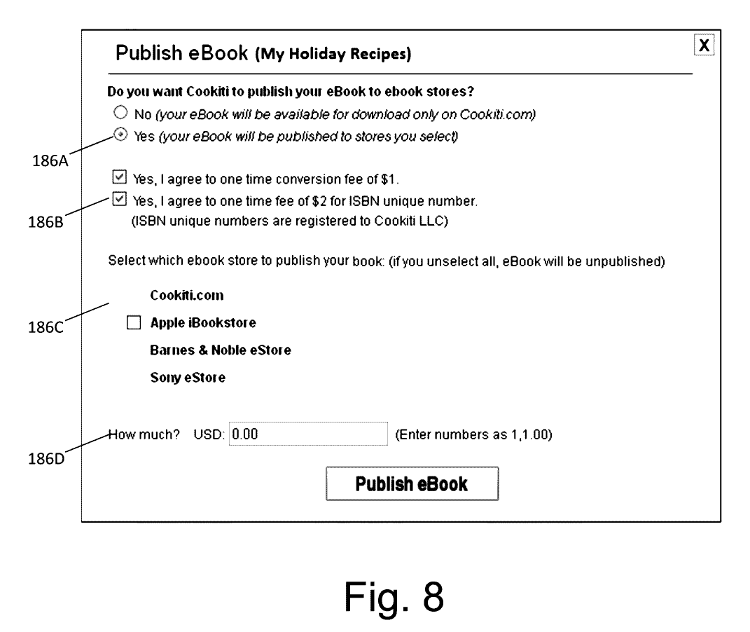

According to an embodiment of the present invention, the share method 181 in FIG. 2 allows users to share access to the book with selected colleagues, groups or public. The share method is detailed in FIG. 4. The method allows owner of book to release it to the public 181A which would normally be done once book is done, and more importantly the method allows user to grant ‘modify’ access 181C to colleagues and other members registered with system 181B; members added in 181B become effectively co-authors, thus allowing them to add their own documents and favorite documents to the book. The share method also allows owner to define cost once the book is shared with the public. It allows user to share if for free, accept donations, or set an access fee 181D. Lastly, the share method allows user to create an eBook version of the book 181E which is detailed further in FIG. 8.

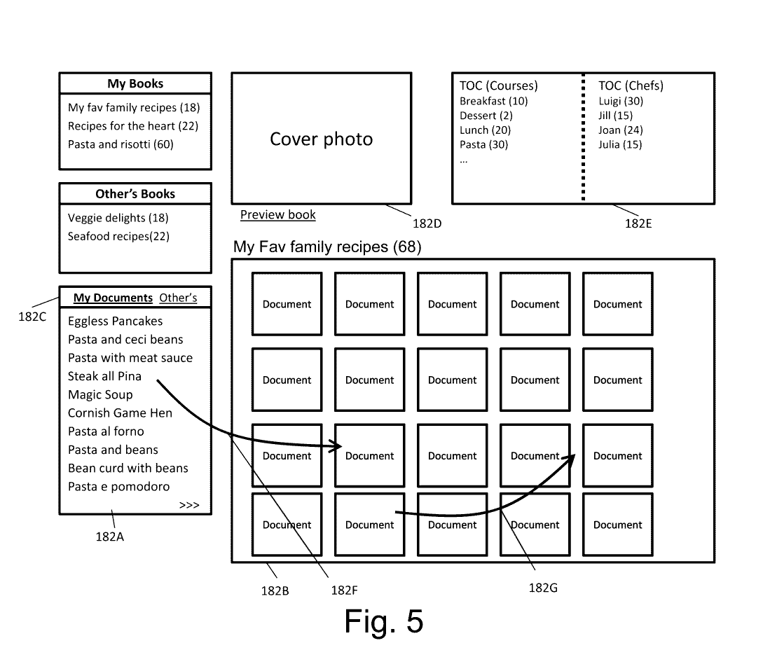

According to an embodiment of the present invention, the book organizer method 182 of FIG. 2 gives users the ability to add documents from own document box, sort and remove documents. The book organizer method is detailed in FIG. 5. According to an embodiment of the present invention, the book organizer method determines how users “add” recipes to book. The method allows users to perform this task with a single drag action 182F of a document from document selector 182A to the book organizer 182B both accessible within the same screen. The preview method 182D gives user instant feedback on book layout and pagination, while the method 182E gives user the ability to filter documents by chapter and therefore ability to check which documents will be part of each individual TOC chapter.

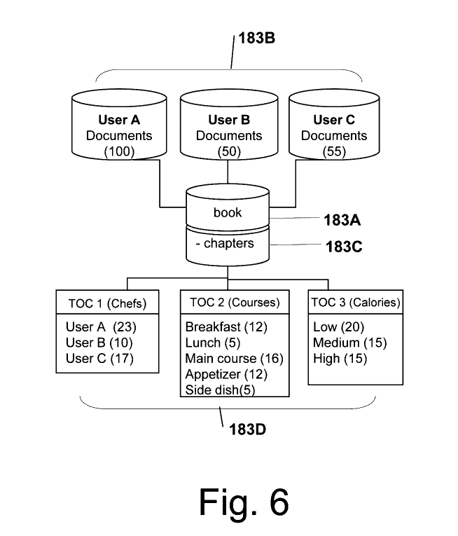

According to an embodiment of the present invention, the compute method 183 of FIG. 2, further detailed in FIG. 6, automatically updates the active tables of content as documents are added, moved, or removed from book organizer. Each line item in a table of content effectively represents a virtual chapter of the book that user can jump to and browse. The computed chapters have overlapping content filtered by the table of content type and sorted according to the sequence of documents specified in organizer 182.

Update Tables of Content

According to an embodiment of the present invention, FIG. 6 shows the internal representation of books. The book properties, such as title, templates, introduction, etc. are stored in the book data store 183A. The book data store includes all document IDs that belong to the book and sourced from different users 183B. The chapters data store 183C includes the list of table of contents (TOC) selected for the book. The content of each TOC is determined thru a select query in book 183A with a filtering criteria in documents table; the output of the query is the list of documents in book that belong to a chapter.

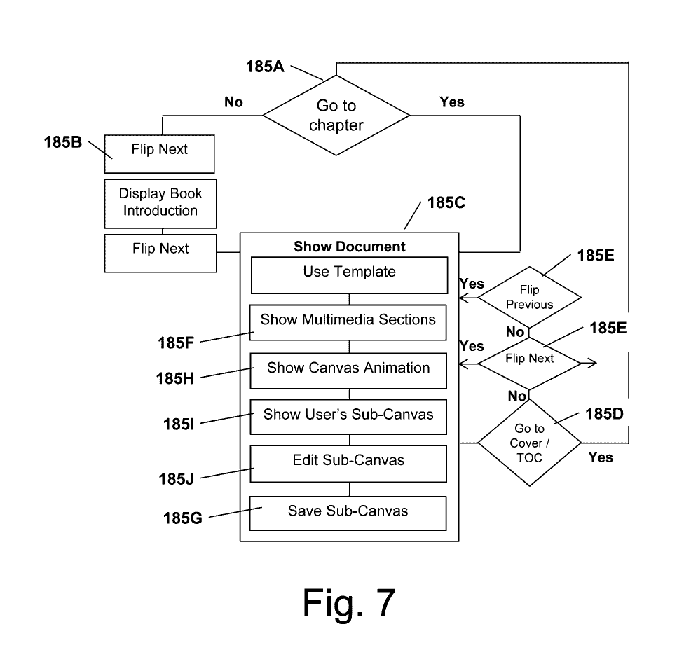

According to an embodiment of the present invention, the output of select queries are cached in the TOC data stores 183D; they represent the chapters to be used to navigate the book, as detailed in FIG. 7. Method 184 in FIG. 2 allows user to sort documents in book organizer which will invoke the method 183 in FIG. 2 to update the tables of content. Similarly, if user chooses to add another document to book organizer, it will cause the table of contents to be updated 183.

The Book Navigation

Turning now to FIG. 7, the book navigation 185 of FIG. 2 allows for viewing and navigating the online book (and corresponding eBook). The navigation method 185A allows user to flip through the sequence of pages and documents in book 185B or navigate directly to an individual chapter and flip through the documents 185C in the selected chapter. The method 185D allows user to navigate back to the cover page of the book. The method 185E allows user to flip to next document or flip back to previous document in book or chapter. The method 185H allows user to view each document's media in place within the page. The method 185I allows user to view a document's video in place within the page, a canvas animation, or a paintable canvas. The interactivity capabilities in 185F through 185J are detailed further in the ePub conversion section below.

The publish method 186 of FIG. 2 is detailed in FIG. 8 which uses the ePub Converter method 187 of FIG. 2. and is detailed in FIG. 9. The ePub converter method creates a standard ePub formatted file that can be transmitted to eBook stores or downloaded to tablet devices or any reader device capable of reading such standard files. The eBook publishing gateway 188 of FIG. 2 handles the actual transfer of the ePub file to the eBook stores. The publishing gateway is prior art and provided as service from external provider.

The Publish Method 186 of FIG. 2

Turning now to FIG. 8, Option 186A gives user the option to publish eBook to web sites and to eBook stores. In order to publish to eBook stores the publish method assigns an ISBN number 186B to the eBook. ISBN numbers are pre-loaded from a data store. The next step in publish method is to store the user preference 186C of which eBook stores to publish eBook. Lastly, compute the eBook listing price. The optional add-on fee 186D to the book price would be to cover publishing fees imposed by eBook stores or other intermediary fees.

The eBook Converter Method 187 of FIG. 2

Turning now to FIG. 9, This method for converting the created online book to the ePub format can be applied to generate other standard eBook formats. The purpose of this step is to create an ePub archive file that is composed by a set of required ePub files 187L, xhtml (html5) files, pdf files, css files, and supporting images.

According to an embodiment of the present invention, the first step in this process is to read in all sections templates, including the user selected cover page template 187A and document pages template 187B. Each section of the book has a corresponding template, cover, introduction, table of contents, and documents, and each template containing placeholders, special tags delimited by curly brackets, to be replaced with the actual content of the book.

According to an embodiment of the present invention, the next step in the process is to generate the cover.html file from template 187C; the cover data will include owner, title, subtitle, the brief intro, and cover image. The layout data of the cover, i.e. positioning of various data elements and supporting images and background, are part of and referenced within the template itself. According to an embodiment of the present invention, the algorithm that takes place in this step 187C is to replace the special delimited tags {Book:authors}, {Book:authors_text} and any other field from book table in format {Book:<field>} with the actual data from the book. “cover.html” is not included directly in epub, but webshot of generated page is taken and image of cover is stored in epub and included in book.opf with property “cover-image”

According to an embodiment of the present invention, the next step is to process the introduction.html template and generate the introduction page based on the content in book.

According to an embodiment of the present invention, the next step is to generate the document.html sections from the document template by iterating for each document in book 187D. Each of the document template's special tags are replaced with the actual content of the documents 187D, i.e. title, description, categories, sections, remarks. As important part of document, document's sections are added where {Document:sections} is in template, and categories/attributes are added where {Document:attributes} is in template. During this process all document and section images and videos (in h264 mp4 files) are included in templates (using img and video tags).

According to an embodiment of the present invention, default document template images are then added to document.html 187E.

According to an embodiment of the present invention, after processing all documents in book 187H, next step is to read and process the TOC template and generate the TOC html. Main table of content is contained in html file (not in .ncf file like in epub2), and can point to other TOC files (e.g. TOC by author). Finally, the CSS style sheets are added to the epub assembly 187J. While processing CSS files, all images included in them are also added to epub.

At step 187K, the system generates the actual ePub file consisting of an assembly of the various html, image and video files and of the ePub required meta-data, book.opf files. The method for creating the required epub files and files compression is prior art.

In the Last step 187L in the ePub conversion process is the validation of the ePub compressed file. Validation is required for being able to publish ePub files through online e-stores and it's done through an internal epub check component invoked programmatically.

Interactivity within ePub Archive—the Interactive eBook

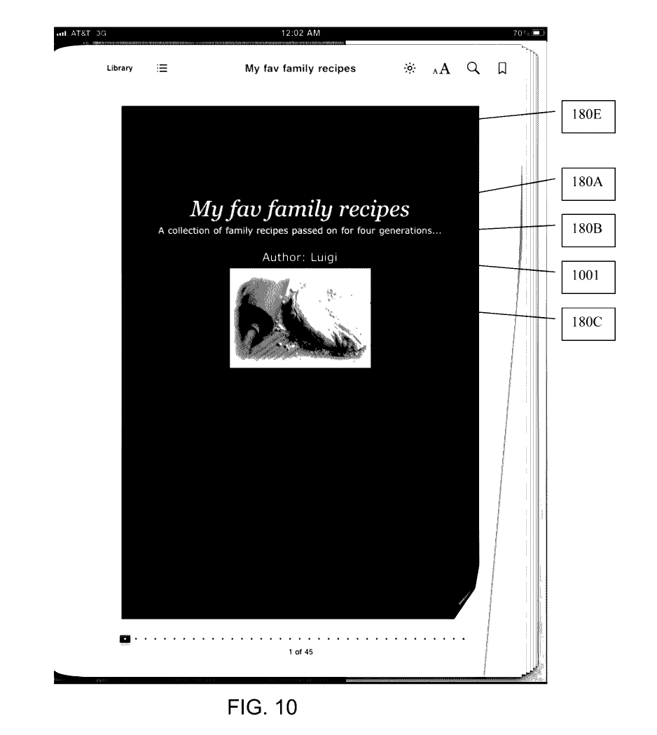

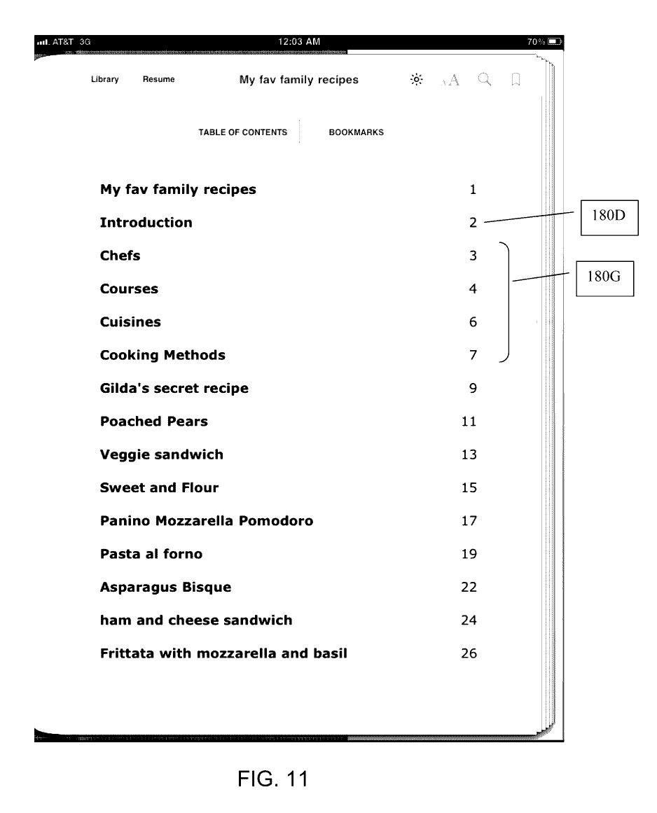

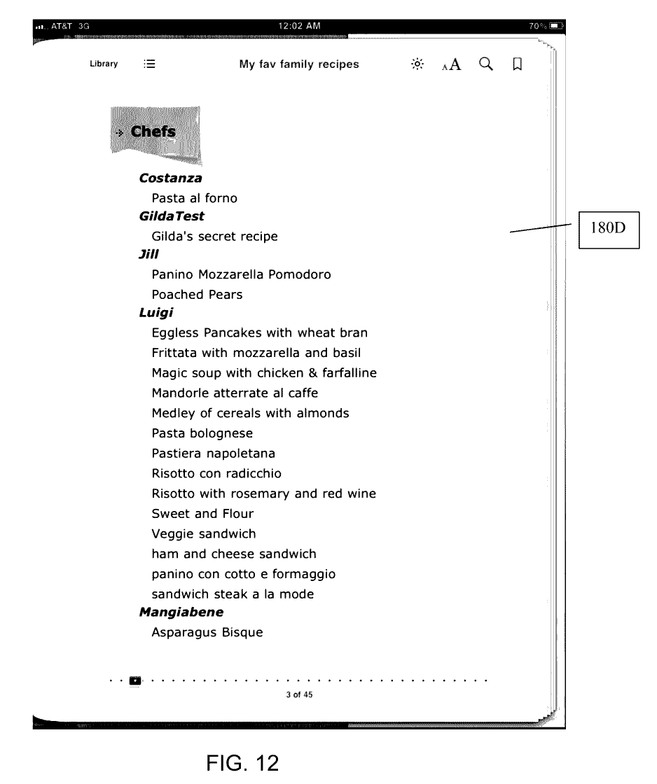

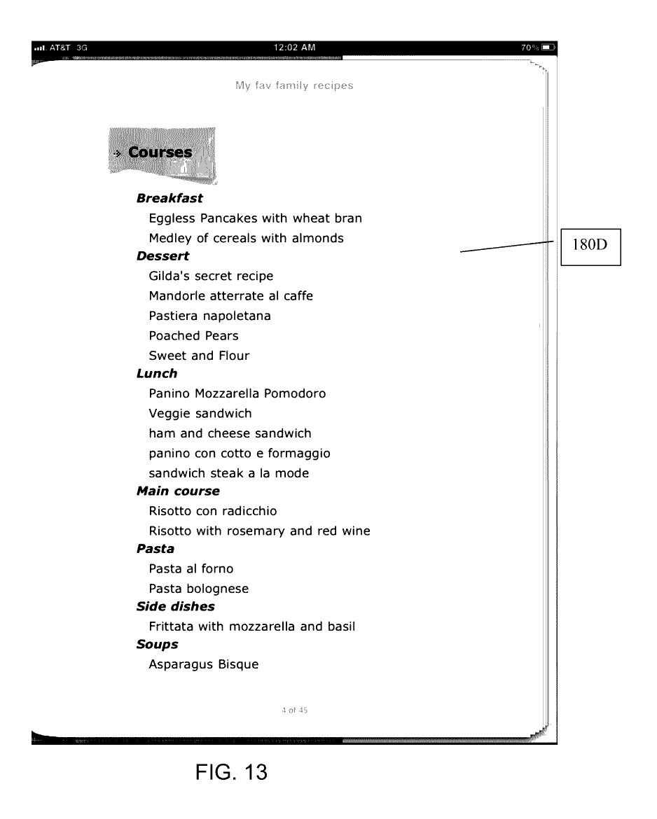

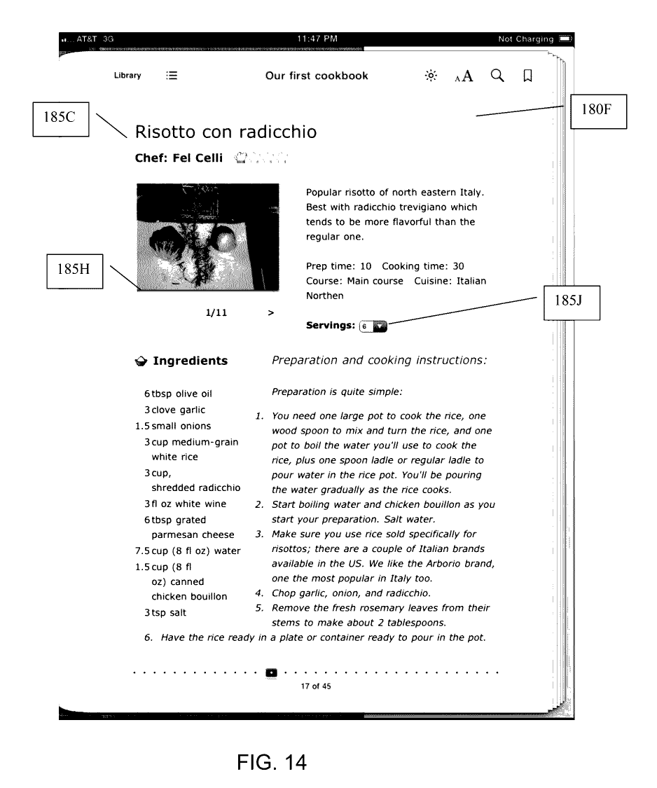

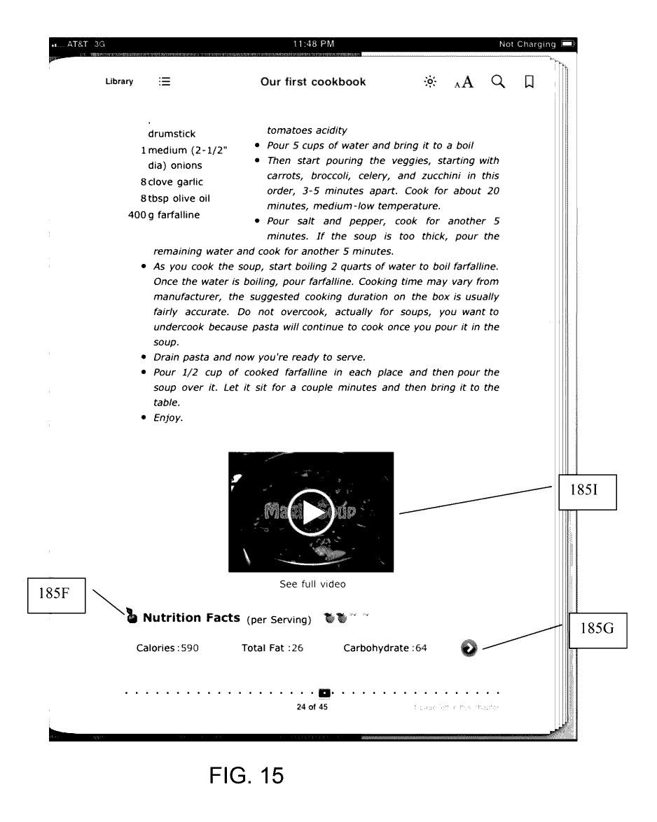

One of the elements of the ePub archive is an epub.js JavaScript file with methods that implement interactivity in eBooks. Books use JavaScript by adding epub.js file (mime-type: “text/JavaScript”) to the ePub, and including a reference in each document.html before ending head tag. The suggested implementation FIG. 10-15 uses the above method to personalize the eBook viewing experience. Current methods in epub.js allow eBook users to play animated canvas or paint canvas. Same technique can be used to add further interactivity and personalization of user experience.

According to an embodiment of the present invention, the account management methods for computing revenue splits on eBooks and buying credits through the payment gateway apply to this Instructional Interactive eBooks as well.

According to an embodiment of the present invention, the communications means of the eBook creator module may be, for instance, any means for communicating data over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the eBook creator module may be comprised of computer-executable code stored in non-transitory memory and configured to instruct a processing means (e.g., CPU) to process the computer-executable code in order to perform the desired functionality described herein. The eBook creator module is configured to receive one or more files from one or more sources. The files contain various documents, templates, files, text, media, formulas, and settings. The sources providing the files to the eBook creator module may include, but are not limited to, submission from a user, provided from a data store (e.g., database, storage medium, cloud storage, image provider) or any combination thereof.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It will be understood that throughout this disclosure e-book and eBook are interchangeably used to denote an electronic book, consisting of a collection of documents. These eBooks can reside on and be viewed from a web server or reside on mobile devices. When an eBook resides on a mobile device it means that eBook was downloaded to that device from a web server and the user does not need to be connected to the internet to view the eBook. When an eBook is viewed from a web server it means that reading device is an internet connected device.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

1. A system for the collaborative publication of interactive multimedia content, the system comprising:
an eBook creator module comprising physical memory storing instructions that cause the project initialization module to;
provide a user interface to a user;
receive a initialization request from said user;
present one or more pre-built book cover templates to said user;
receive a book cover selection from said user; wherein said book cover selection is chosen from said one or more pre-built book cover templates;
present one or more document page templates to said user;
receive a document page template selection from said user, wherein said document page template selection is chosen from said one or more document page templates;
present one or more book navigation methods to said user;
receive a book navigation method selection from said user, wherein said book navigation selection method selection is chosen from said one or more book navigation methods;
provide said user with a document manager module, wherein said document manager module is configured to allow said user to create and edit book content;
provide said user with an eBook manager module, wherein said eBook manager module is configured to create an electronic online book comprising of said book cover selection, said document page template selection, said navigation method selection, and said book content; and
publish said electronic online book, wherein said online book is distributed through online bookstores.

2. The system of claim 1, wherein said eBook creator module may be utilized by a plurality of users simultaneously.

3. The system of claim 2, wherein said plurality of users can contribute collectively to said book content.

4. The system of claim 1, further comprising a canvas editor; wherein said canvas editor allows said user to create and incorporate one or more elements from the group comprising drawings, sketches, handwriting, diagrams, images, formulas into said book content.

5. The system of claim 4, wherein the canvas editor allows the user reading book content to play, pause, and stop a step-by-step animation of the canvas elements and to insert add-on content to existing book content, said add-on content being accessible only to said user.

6. The system of claim 5, wherein said add-on content is further accessible to one or more of a document author and a limited number of secondary users, wherein said secondary users are first given access privileges by said user.

7. The system of claim 1, further comprising a document editor; wherein said document editor allows said user to create any number of properly formatted sections comprising of rich text, images, video, canvas, and other public media or web pages available from other web sites.

8. The system of claim 1, further comprising an accounts manager module; wherein said accounts manager module controls said user's account access, preferences, and privileges.

9. The system of claim 1, further comprising a configuration manager, wherein said configuration manager offers said user an ability to designate properties of said document as required or optional.

10. The system of claim 1, further comprising a communications means, wherein said communications means allows said eBook creator module to utilize a computer network.

11. The system of claim 1, further comprising a data store, wherein said data store comprises templates, files, formulas, and settings that are utilized by said eBook creator module.

12. A computer implemented method for the collaborative publication of interactive multi-media content, the method comprising the steps of:
providing a user interface to a user;
receiving a initialization request from said user;
presenting one or more pre-built book cover templates to said user;
receiving a book cover selection from said user; wherein said book cover selection is chosen from said one or more pre-built book cover templates;
presenting one or more document page templates to said user;
receiving a document page template selection from said user, wherein said document template selection is chosen from said one or more document page templates;
presenting one or more book navigation methods to said user;
receiving a book navigation method selection from said user, wherein said book navigation selection method selection is chosen from said one or more book navigation methods;
providing said user with a document manager module, wherein said document manager module is configured to allow said user to create and edit book content;
providing said user with an eBook manager module, wherein said eBook manager module is configured to create a book comprising of said book cover selection, said document page template selection, said navigation method selection, and said book content; and
publishing said electronic online book, wherein said online book is distributed through online bookstores.

13. The method of claim 12, further comprising the step of sharing said book with a group, wherein said group can edit and contribute said book content to said book.

14. The method of claim 12, further comprising the step of distributing said book; wherein said book is distributed for monetary compensation.

15. The method of claim 12, further comprising the step of incorporating one or more elements from the group comprising drawings, sketches, handwriting, images, diagrams and formula, via a canvas editor, into said book content.

16. The method of claim 15, further comprising the steps of:
playing a step-by-step animation of the canvas elements;
stopping said step-by-step animation of the canvas elements;
pausing said step-by-step animation of the canvas elements; and
inserting add-on content to existing book content, via a canvas editor, said add-on content being accessible only to said user.

17. The method of claim 16, wherein said add-on content is further accessible to one or more of an original author of a document, and a limited number of secondary users, wherein said secondary users are first given access privileges by said user.

18. The method of claim 12, further comprising the step of creating properly formatted sections for said document, via a document editor and comprising of rich text, images, canvas, video, and other public media or web pages available from external web sites.

19. The method of claim 18, further comprising the step of a document author allowing other users create derived content from an original document and then automatically collating said derived content with original document in chapters of ebook.

20. The method of claim 12, further comprising a data store, wherein said data store comprises templates, files, formulas, and settings that are utilized by said eBook creator module.
